(19) United States
(12) Patent Application Publication
(10) Pub. No.: US 2012/0014589 A1
(43) Pub. Date: Jan. 19, 2012

(54) METHOD FOR ANALYZING PERIPHERAL COMPONENT INTERCONNECT SOCKETS

(75) Inventors: CHIH-YANG LIN, Tu-Cheng (TW); WEI-CHIANG LEE, Tu-Cheng (TW)

(73) Assignee: HON HAI PRECISION INDUSTRY CO., LTD., Tu-Cheng (TW)

(21) Appl. No.: 13/028,157

(22) Filed: Feb. 15, 2011

(30) Foreign Application Priority Data
Jul. 14, 2010 (TW) 99123056

(51) Int. Cl. G06K 9/00

(52) U.S. Cl. 382/150

(57) ABSTRACT

A method uses a time domain reflectometer (TDR) to determine unqualified clasps of a peripheral component interconnect (PCI) socket. A scanning electron microscope (SEM) captures an image of an unqualified clasp and magnifies the image from a nanometer scale to view the unqualified clasp. An electron spectroscopy for chemical analysis (ESCA) obtains a degree of oxidation at each position of the unqualified clasp in response to a determination that the unqualified clasp is oxidated. A Fourier transform infrared spectroscopy (FTIR) displays a position of the soldering flux using in response to the determination that the unqualified clasp comprises the soldering flux.

### BACKGROUND

1. Technical Field

Embodiments of the present disclosure relate to analysis technology, and particularly to a method for analyzing peripheral component interconnect sockets.

2. Description of Related Art

A peripheral component interconnect (PCI) socket is a mechanical structure that is used to connect a computer-based card to the PCI socket of a computerized system. For example, a graphic card can be connected to a motherboard of the computerized system by plugging into a PCI socket of the motherboard. However, if the PCI socket is oxidated (“unqualified”), the two joint devices may not communicate with each other. In such a case if the PCI socket is oxidated, an electric circuit between the graphic card and the PCI socket may be cut off so that the graphic card may not communicate with the motherboard.

### BRIEF DESCRIPTION OF THE DRAWINGS

FIG. 1 is a systematic diagram of one embodiment of a peripheral component interconnect (PCI) socket analysis system.

FIG. 2 is a flowchart of one embodiment of a method for analyzing a PCI socket.

FIG. 3 is a systematic diagram of one embodiment of determining unqualified clasps of the PCI socket.

FIG. 4 is a cross-sectional view of an exemplary clasp of the PCI socket.

FIG. 5 illustrates metal layers of an exemplary qualified clasp of the PCI socket.

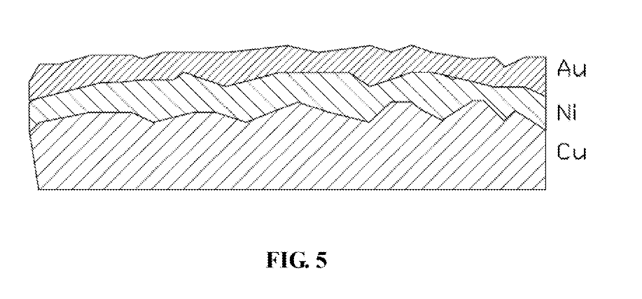

FIG. 6 illustrates metal layers of an exemplary unqualified clasp of the PCI socket.

FIG. 7 is an exemplary magnified diagram of a marked part VI in FIG. 5.

### DETAILED DESCRIPTION

All of the processes described below may be embodied in, and fully automated via, function modules executed by one or more general purpose processors of a computer. Some or all of the methods may alternatively be embodied in specialized hardware. The function modules may be stored in any type of computer-readable medium or other computer storage device.

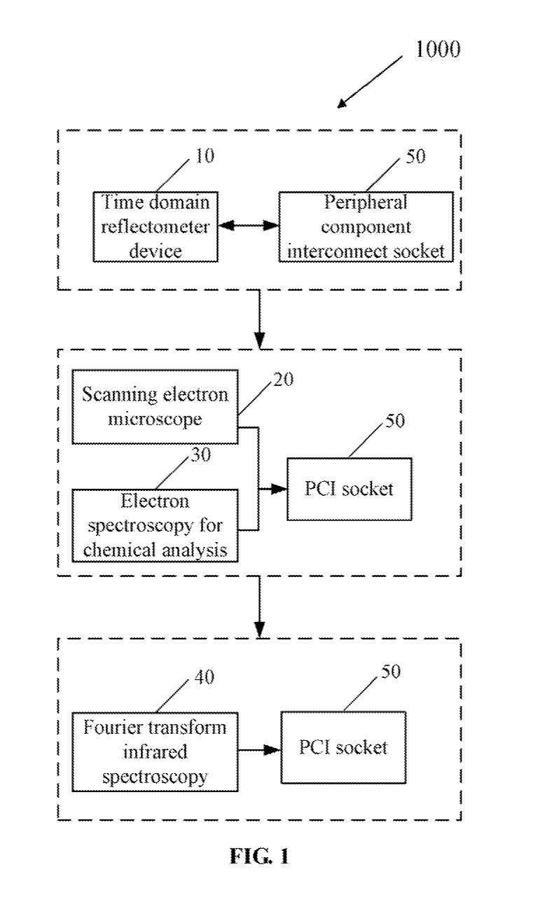

FIG. 1 is a systematic diagram of one embodiment of a peripheral component interconnect (PCI) socket analysis system 1000. The PCI socket analysis system 1000 can be used to automatically analyze a PCI socket 50 to determine unqualified clasps 500 of the PCI socket 50. The socket analysis system 1000 includes a time domain reflectometer (TDR) 10, a scanning electron microscope (SEM) 20, an electron spectroscopy for chemical analysis (ESCA) 30, a Fourier transform infrared spectroscopy (FTIR) 40 and the PCI socket 50. It is understood that the PCI socket 50 is a mechanical structure that can receive PCI cards (e.g., PCI graphic cards). The PCI socket 50 may be, but is not limited to, a graphic card socket.

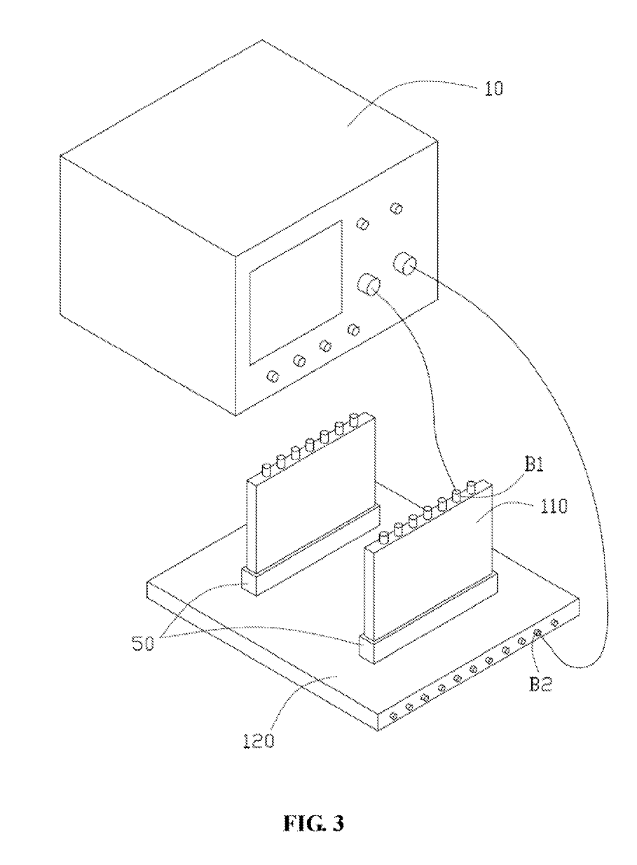

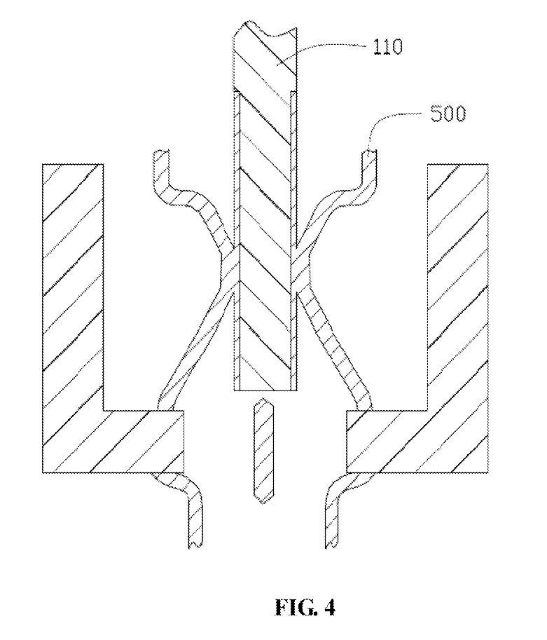

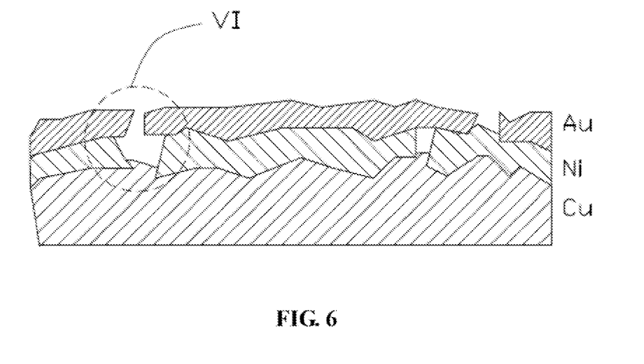

In some embodiments, the TDR 10 is electronically connected to the PCI socket 50, as shown in FIG. 1. As shown in FIG. 3, the PCI socket 50 is on a platform 120 and is electronically connected to a test card 110 (e.g., a PCI graphic card). The PCI socket 50 includes one or more clasps 500. It is understood that each two of the clasp 500 is defined as holding a pin of the test card 110 to communicate with the test card 110. For example, each two of the clasps 500 hold a pin of the test card 110, as shown in FIG. 4. The test card 110 has one or more terminals, such as B1. The platform 120 has one or more terminals, such as B2. The TDR 10 is connected to a terminal of the test card 110 and a terminal of the platform 120 using two electrical cables to determine if each of the clasp 500 is qualified. For example, the TDR 10 is connected to B1 and B2 to determine if each of the clasp 500 is qualified. It is understood that a qualified clasp 500 is defined as a structure that contains three metal layers (the top metal layer is a gold (Au) layer, the second layer is a nickel (Ni) layer, and the third layer is a copper (Cu) layer) being sandwiched together in a substantially even contact with each other along the whole width/length of the substrate. The Cu layer is in a substantially continuous, direct contact with the Ni layer. The Ni layer is in substantially continuous, direct contact with the Au layer. It is understood that an unqualified clasp 500 is defined as a structure that has one or more pits among the three metal layers (Au, Ni, Cu). For example, as shown in FIG. 6, the unqualified clasp 500 has a pit (e.g., reference part VI) among the three layers. The pit may run one of more layers of the metal layers causing the at least one of the metal layers to not be in substantially even contact along the whole width/length of the other metal layers. Details of how the TDR 10 determines for unqualified claps is described below.

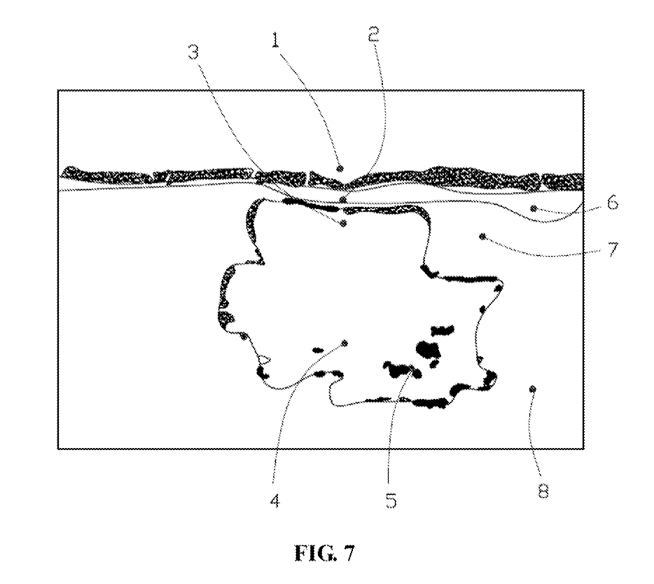

The SEM 20 is electronically connected to the PCI socket 50. In one embodiment, the SEM 20 captures an image of each of the unqualified clasp 500. When viewing the unqualified clasp 500 from a nanometer scale, the SEM 20 magnifies the image. Magnification of the image may be at 1,000,000×, for example. As shown in FIG. 6, the SEM 20 views the marked part VI of the unqualified clasps 500 from the nanometer scale to get a magnified image of the marked part VI, as shown in FIG. 7.

The ESCA 30 is electronically connected to the PCI socket 50. The ESCA 30 analyzes the unqualified clasps 500 using the magnified image to determine if the unqualified clasp 500 is oxidated. In one example, a user may manually determine if the unqualified clasp 500 includes oxides (e.g., copper oxide or nickel oxide). For example, the user can choose one or more positions of the unqualified clasp 500 to determine if each of the position of the unqualified clasp 500 includes oxides. It should be understood that the Au layer is typically a golden color. If a manual analysis of the unqualified clap 500 shows that the unqualified clasp 500 is other than a golden color, then the unqualified clap 500 may be oxidated. For example, as shown in FIG. 7, the user chooses the positions from 1 to 8 and uses the ESCA 30 to determine if the unqualified clasp 500 includes oxides at each of the positions from 1 to 8.

The ESCA 30 also obtains a degree of oxidation at each position of the unqualified clasps 500 in response to a determination that the unqualified clasp 500 is oxidated. The degree of oxidation at each position of the unqualified clasp 500 is equal to the oxidation content at the position of the unqualified clasp 500. The ESCA 30 obtains a table to show a content of each of the element when analyzing the marked part VI. The table is shown as follows:

| | Element | | | | | | |
|---|---|---|---|---|---|---|---|
| Position | Au | Ni | Cu | O | Cl | Total | Material |
| 1 | 39.1% | 26.8% | — | 29.3% | 4.8% | 100% | NiOx |
| 2 | 84.3% | 4.3% | 4.2% | 7.2% | — | 100% | NiOx |
| | | | | | | | CuOx |
| 3 | — | 53.5% | — | 35.0% | 11.5% | 100% | NiOx |
| 4 | — | 50.0% | — | 37.7% | 12.3% | 100% | NiOx |
| 5 | — | 50.4% | 17.4% | 21.9% | 10.3% | 100% | CuOx |
| 6 | 100% | — | — | — | — | 100% | Au |
| 7 | — | 100% | — | — | — | 100% | Ni |
| 8 | — | — | 100% | — | — | 100% | Cu |

According to the above table, the oxides are determined at the positions 1-5 (referring to the FIG. 7), and the unqualified clasp 500 is oxidated at the positions 1-5, the degree of oxidation at each position is equal to the oxidation content at the position. For example, the NiOx is determined at the position 1, the unqualified clasp 500 is oxidated at the position 1, the degree of oxidation at the position 1 is 29.3%. Additionally, x of the NiOx and the CuOx denotes a subscript of the element oxygen.

The FTIR 40 is also electronically connected to the PCI socket 50. In one embodiment, the FTIR 40 determines if the unqualified clasp 500 includes soldering flux. In one embodiment, the soldering flux emits infrared radiation with a predetermined wavelength range between 200 and 220 micrometers. The FTIR 40 obtains the wavelength of the infrared radiation from the unqualified clasp 500. If the obtained wavelength of the infrared radiation falls in the predetermined wavelength range between 200 and 220 micrometers, the unqualified clasp 500 includes the soldering flux. Additionally, the FTIR 40 displays a position of the soldering flux in response to a determination that the unqualified clasp 500 includes soldering flux.

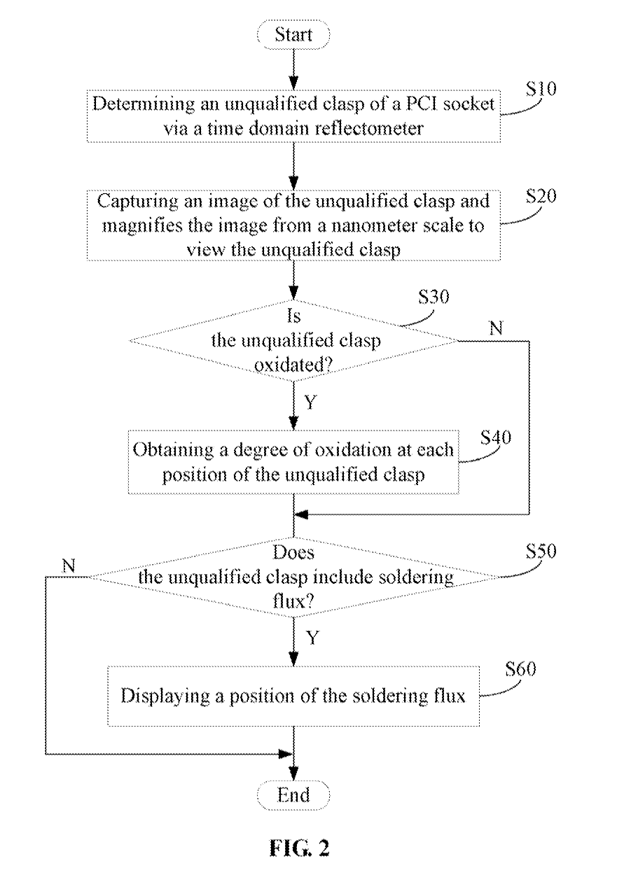

FIG. 2 is a flowchart of one embodiment of a method for analyzing clasps of the PCI socket 50. The method may be used to analyze the PCI socket 50 to determine unqualified clasps 500 of the PCI socket 50. Depending on the embodiment, additional blocks may be added, others deleted, and the ordering of the blocks may be changed.

In block S10, the TDR 10 determines unqualified clasps 500 of the PCI socket 50. In one embodiment, the TDR 10 generates an impulse (e.g., a low-energy electromagnetic impulse) and sends the impulse to a surface of the clasp 500. When the impulse hits the surface of the clasp 500, part of the impulse is reflected back to the TDR 10, the TDR 10 calculates a time difference between the sent impulse and the reflected impulse. If the calculated time difference is equal to a predetermined time difference (e.g., 2 nanoseconds), the clasp 500 is qualified and has no pits among the three metal layers. If the calculated time difference is not equal to a predetermined time difference, the clasp 500 is unqualified and has one or more pits among the three metal layers.

In block S20, the SEM 20 captures an image of each unqualified clasp 500 and magnifies the image from a nanometer scale to view the unqualified clasp 500. In one embodiment, the magnification of the image may be at 1,000,000× for example.

In block S30, the ESCA 30 analyzes the unqualified clasps 500 using the magnified image to determine if the unqualified clasp 500 is oxidated. For example, if the unqualified clasp 500 is oxidated, the ESCA 30 obtains a degree of oxidation at each position of the unqualified clasp 50, then the procedure goes to block S40. If the unqualified clasp 500 is not oxidated, the procedure goes to block S50.

In block S40, the ESCA 30 obtains a degree of oxidation at each position of the unqualified clasp 500. As mentioned above, the degree of oxidation at each position of the unqualified clasp 500 is equal to the oxidation content at the position of the unqualified clasp 500.

In block S50, the FTIR 40 determines if the unqualified clasp 500 includes soldering flux. For example, as shown in FIG. 7, the FTIR 40 obtains the wavelength of the infrared radiation at the position 1, if the obtained wavelength of the infrared radiation at the position 1 is 202 micrometers, the unqualified clasp 500 includes the soldering flux at the position 1, the procedure goes to S60. If the obtained wavelength of the infrared radiation at the position 1 is 100 micrometers, the procedure goes to end.

In block S60, the FTIR 40 displays a position of the soldering flux in response to a determination that the unqualified clasp 500 include the soldering flux.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for analyzing a peripheral component interconnect (PCI) socket comprising clasps, the method comprising:
providing a time domain reflectometer (TDR), a scanning electron microscope (SEM), an electron spectroscopy for chemical analysis (ESCA) and a Fourier transform infrared spectroscopy (FTIR);
determining an unqualified clasp of the PCI socket using the TDR;
capturing an image of the unqualified clasp and using the SEM to magnify the image from a nanometer scale to view the unqualified clasp;
determining if the unqualified clasp is oxidated using the ESCA;
obtaining a degree of oxidation at each position of the unqualified clasp using the ESCA in response to a determination that the unqualified clasp is oxidated;
determining if the unqualified clasp comprises soldering flux using the FTIR; and
displaying a position of the soldering flux using the FTIR in response to the determination that the unqualified clasp comprises the soldering flux.

2. The method of claim 1, wherein the PCI socket is a graphic card socket.

3. The method of claim 1, wherein the block of determining for unqualified clasps of the PCI socket using the time domain reflectometer (TDR) comprises:
generating an impulse using the TDR and sending the impulse to a surface of the clasp;
receiving a reflected impulse from the surface of the clasp using the TDR;
calculating a time difference between the sent impulse and the reflected impulse using the TDR; and
determining the clasp is unqualified using the TDR in response to a determination that the calculated time difference is not equal to a predetermined time difference.

4. The method of claim 1, wherein the unqualified clasp is oxidated upon the condition that the unqualified clasp comprises oxides.

5. The method of claim 1, wherein the degree of oxidation at each position of the unqualified clasp is equal to an oxidation content at the position.

6. The method of claim 1, wherein the block of determines if the unqualified clasp comprises the soldering flux using the Fourier transform infrared spectroscopy (FTIR) comprises:
obtaining a wavelength of an infrared radiation from the unqualified clasp;
determining the unqualified clasp comprises the soldering flux upon the condition that the obtained wavelength of the infrared radiation falls in a predetermined wavelength range.
